(19) United States
(12) Patent Application Publication
(10) Pub. No.: US 2015/0036186 A1
(43) Pub. Date: Feb. 5, 2015

(54) INFORMATION PROCESSING APPARATUS AND CONTROL METHOD FOR THE INFORMATION PROCESSING APPARATUS

(71) Applicant: CANON KABUSHIKI KAISHA, Tokyo (JP)

(72) Inventor: Fumio Mikami, Chigasaki-shi (JP)

(21) Appl. No.: 14/447,264

(22) Filed: Jul. 30, 2014

(30) Foreign Application Priority Data
Jul. 31, 2013 (JP) 2013-158464

(51) Int. Cl. G06K 15/02

(52) U.S. Cl. CPC G06K 15/1828; G06K 15/1809
USPC 358/1.15

(57) ABSTRACT

A CPU of the image forming apparatus measures a data transfer speed to an SSD for every print page, and a time-out period (paper jam detection period) for determining occurrence of a time-out associated with processing (print job) including an access to the SSD is changed in accordance with the data transfer speed determined to be lower than a predetermined value.

### BACKGROUND

1. Technical Field

The present disclosure relates to an information processing apparatus and a control method for the information processing apparatus.

2. Description of the Related Art

In recent years, an information processing apparatus has been provided with a solid state drive (SSD) instead of a hard disk drive (HDD) in many cases. Japanese Patent Laid-Open No. 2012-234321 discloses a technology for measuring reading and writing speeds from and to a flash memory such as an SSD and determining degradation caused at the end of a lifespan of the flash memory on the basis of a decrease in the speeds.

Before an SSD or the like reaches the end of its lifespan, the transfer speed may be temporarily decreased in some cases. In general, the SSD or the like performs processing of reorganizing data by using backup areas and unused areas in accordance with the amount of written data. This reorganizing processing is called garbage collection. However, while the garbage collection is in progress, the transfer speed is decreased. To give an example, an operation is carried out with a writing speed of 200 [MB/sec], but the writing speed is decreased to 70 [MB/sec] during the garbage collection operation, and once the garbage collection is ended, the writing speed returns to 200 [MB/sec].

The garbage collection is occasionally performed when the write amount to the SSD or the like is being increased, and an external part of the SSD can determine whether or not the garbage collection is being performed only on the basis of a situation where the transfer speed has temporarily decreased.

### SUMMARY

In an image forming apparatus, timer monitoring is performed for a period spent forming an image on a paper medium, but in an image forming apparatus mounted with an SSD, a condition for time-out in print processing or the like may be satisfied in some cases because of a decrease in the transfer speed caused by the garbage collection in the SSD.

In this case, it is difficult to determine a reason why the time-out is caused because of the garbage collection or because of a factor such as a sheet conveying defect (for example, a paper jam). In view of the above, in order that the time-out is not caused even when the garbage collection operation is executed, a method of regularly setting a long time-out determination period is conceivable. However, according to the above-described method, an emergency stop does not work even at the time of an occurrence of the paper jam or a malfunction where the emergency stop is supposed to work, which leads to a problem that a critical fault may be caused in the apparatus.

The present disclosure provides a mechanism in which even in a case where an operation speed of a storage apparatus used for processing is temporarily decreased, functions of an information processing apparatus can be maintained without increasing a cost such as addition of hardware or causing a critical damage to the information processing apparatus.

The present disclosure further provides an information processing apparatus including: a storage apparatus; a measurement unit configured to measure a data transfer speed to the storage apparatus; and a control unit configured to perform a change control to change a time-out period for determining occurrence of a time-out associated with processing including an access to the storage apparatus in accordance with the data transfer speed determined to be lower than a predetermined value.

Further features of the present invention will become apparent from the following description of exemplary embodiments with reference to the attached drawings.

### BRIEF DESCRIPTION OF THE DRAWINGS

FIG. 1 illustrates an image forming apparatus according to an exemplary embodiment of the present invention.

FIGS. 2A and 2B are flow charts illustrating a printing operation and a transfer speed measurement operation performed by an image forming apparatus according to a first exemplary embodiment.

FIG. 3 is a cross sectional view illustrating a configuration of a printer unit of the image forming apparatus.

FIG. 4 illustrates jam codes corresponding to paper jams detected by respective sensors of the image forming apparatus.

FIG. 5 is a flow chart illustrating a printing operation performed by an image forming apparatus according to a second exemplary embodiment.

### DESCRIPTION OF THE EMBODIMENTS

### First Exemplary Embodiment

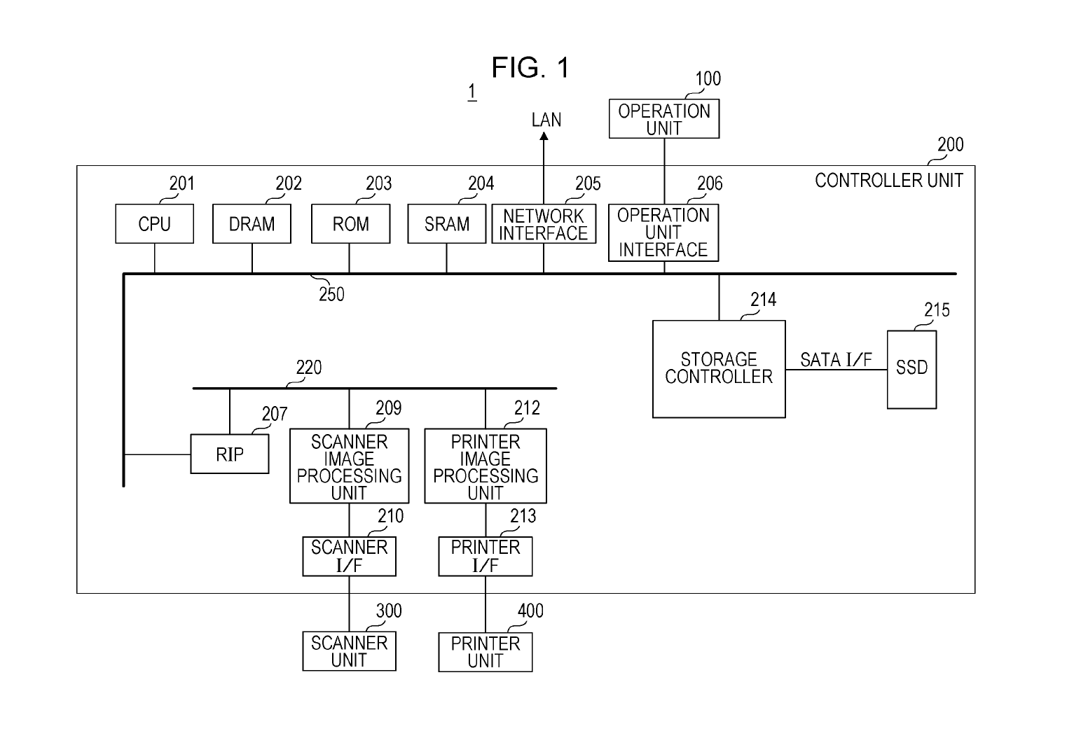

FIG. 1 is a block diagram illustrating an example of an image forming apparatus to which an information processing apparatus according to an exemplary embodiment of the present invention can be applied.

FIG. 1 illustrates an image forming apparatus 1 functioning as the information processing apparatus according to the exemplary embodiment of the present invention. The image forming apparatus 1 is a multifunction peripheral (MFP) or the like and includes an operation unit 100, a controller unit 200, a scanner unit 300, and a printer unit 400.

The operation unit 100 includes a hardware key, a touch panel system display unit, and the like which are not illustrated in the drawing. The operation unit 100 accepts an operation of the image forming apparatus 1 by a user and notifies the user of information such as a message. The scanner unit 300 is a reading unit configured to read an original to generate image data and output the image data to the controller unit 200. The printer unit 400 is a printing unit configured to perform image formation on a sheet on the basis of the image data received from the controller unit 200.

Hereinafter, the controller unit 200 will be described.

The controller unit 200 is electrically connected to the operation unit 100, the scanner unit 300, and the printer unit 400. The controller unit 200 can also perform communication of the image data and device information with a personal computer, an external apparatus, or the like via a local area network (LAN).

A CPU 201 executes a program stored in a ROM 203 or the like in order to control respective devices connected to a system bus 250 in an overall manner. A DRAM 202 is a system work memory for operation of the CPU 201. An SRAM 204 is a memory that operates at a high speed and does not involve a refresh operation.

A network interface 205 is connected to the LAN and the system bus 250 and performs input/output of information with the network. An operation unit interface 206 is an interface unit for connecting the system bus 250 to the operation unit 100. The operation unit interface 206 receives the data to be displayed on the operation unit 100 from the system bus 250 and outputs the data to the operation unit 100 and also outputs the information input from the operation unit 100 to the system bus 250.

A storage controller 214 performs controls such as writing and reading of data to and from an SSD 215. The SSD 215 is a solid state drive. The storage controller 214 is provided with a direct memory access (DMA) control unit that is not illustrated and can perform data transfer to the SSD 215 by way of DMA transfer. The DMA control unit may be provided separately from the storage controller 214.

In the SSD 215, the data writing is performed in units of so-called “pages”. However, data deletion can be performed only in units of “blocks” each of which is composed of a plurality of pages and accordingly larger than the page. Therefore, in a case where data of a certain page in a certain block is not to be used, only a page where data to be used in the block exists is copied to another block, and the block where the above-described data that is not to be used exists is deleted. The SSD 215 has a function of performing such an operation which is called garbage collection.

An RIP unit 207 is a raster image processor and converts a display list converted from PDL data by the CPU 201 into raster data. A scanner image processing unit 209 performs image processing such as correction, processing, or editing on the image input from the scanner unit 300. A printer image processing unit 212 performs image processing such as correction or resolution conversion in accordance with the printer unit 400 on the image data to be transmitted to the printer unit 400.

A scanner I/F 210 connects the scanner unit 300 functioning as an image input device to the controller unit 200. A printer I/F 213 connects the printer unit 400 functioning as an image output device to the controller unit 200.

Here, a printing operation of the image forming apparatus 1 will be described.

When the PDL data corresponding to print data is received by the network interface 205 via the LAN, the received PDL data is temporarily written to the DRAM 202 to be written to the SSD 215 via the storage controller 214. The PDL data in the SSD 215 is converted into a display list by the CPU 201 and written again to the SSD 215 via the DRAM 202. The display list of the SSD 215 is read out and transmitted to the RIP unit 207 to be converted into raster data and written again to the SSD 215. The raster data is read out from the SSD 215 via the system bus 250, passes through the RIP unit 207, goes through an image bus 220, is subjected to density and screen processing and the like by the printer image processing unit 212, and is transmitted to the printer unit 400 to be printed.

A scan operation of the image forming apparatus 1 will be described.

The image data read by the scanner unit 300 is transmitted to the scanner image processing unit 209 via the scanner I/F 210 to be processed. The image data processed in the scanner image processing unit 209 passes through the RIP unit 207 via the image bus 220 and is transferred to the SSD 215 via the system bus 250. In the case of a copy operation, the image data transferred to the SSD 215 is transmitted to the printer image processing unit 212 to be processed and is further transmitted to the printer unit 400 via the printer I/F 213 to be printed.

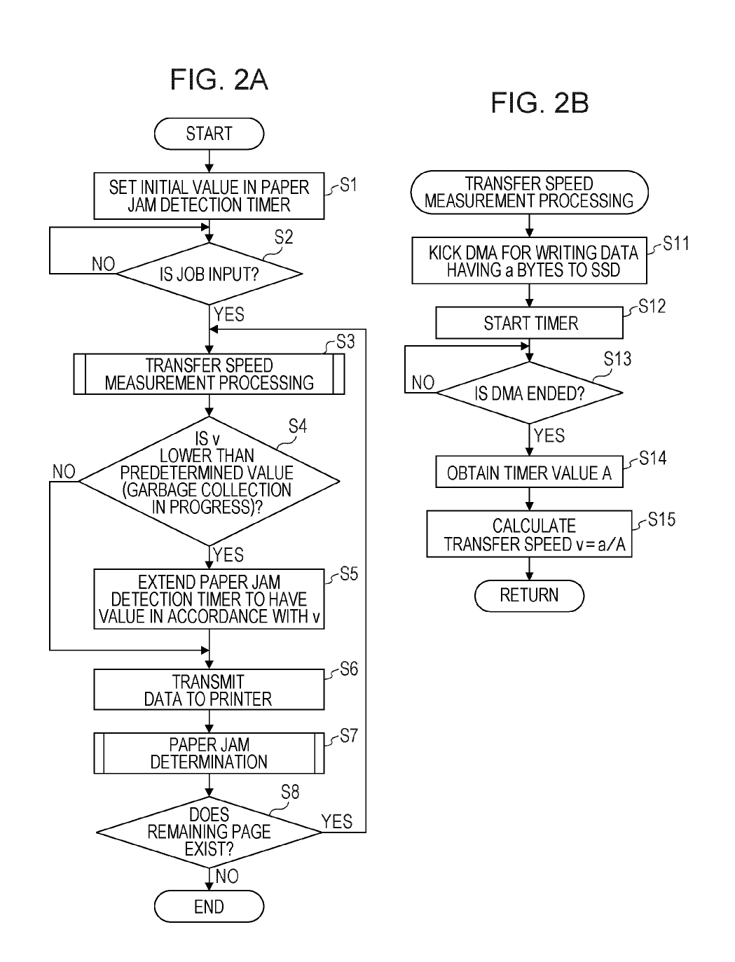

Hereinafter, with reference to FIGS. 2A and 2B, FIG. 3, and FIG. 4, the printing operation of the image forming apparatus 1 according to the first exemplary embodiment will be described.

FIGS. 2A and 2B are flow charts illustrating examples of the printing operation and a transfer speed measurement operation of the image forming apparatus 1 according to the first exemplary embodiment. FIG. 2A corresponds to the entire printing operation, and FIG. 2B corresponds to the transfer speed measurement processing. The processing operations in the flow charts of FIGS. 2A and 2B are realized when the CPU 201 of the controller unit 200 executes the program stored in the ROM 203.

First, by using FIG. 2B, the transfer speed measurement processing will be described.

In S11, the CPU 201 kicks a direct memory access (DMA) for transferring data having a predetermined size (herein, which is set as “a” [Bytes]) from the DRAM 202 to the SSD 215. That is, the CPU 201 instructs a DMA unit (not illustrated) in the storage controller 214 to perform a DMA transfer of data having “a” bytes. Accordingly, the DMA transfer of the data having “a” bytes to the SSD 215 is started. Herein, the data subjected to the DMA transfer is data for the transfer speed measurement, but print data or data of an actual job such as original reading data by the scanner unit 300 may be used. In S12, the CPU 201 starts a timer.

Next, in S13, the CPU 201 waits for the end of the DMA transfer which has started in S11 described above. In a case where it is determined that the DMA transfer is ended (in the case of Yes in S13), in S14, the CPU 201 obtains a timer value A.

Next, in S15, the CPU 201 calculates a transfer speed v and ends the transfer speed measurement processing. A calculation expression for the transfer speed v is “v [Byte/sec]=a [Bytes]/A [sec]”.

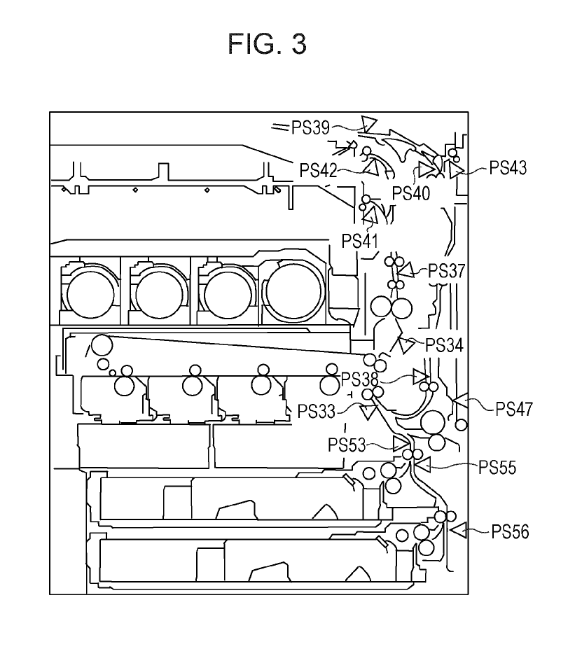

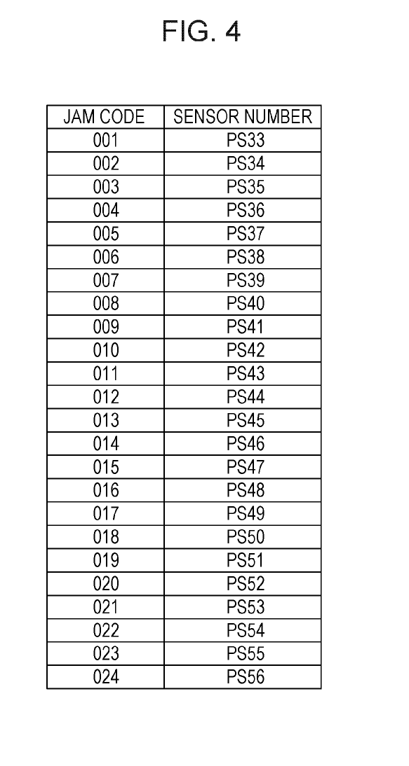

For example, consideration will be given to a case where the print data is transmitted to the printer unit in which a transfer speed of 60 [MB/sec] or higher is to be set to realize the printing of 100 sheets per minute. Here, by referring to FIG. 3 and FIG. 4, a relationship between a data transfer speed and a sheet conveyance speed will be described.

FIG. 3 is a cross sectional view illustrating an example of a configuration of the printer unit 400 of the image forming apparatus 1, in particular, illustrating a part of sensor locations for detecting a passage of the sheet at the time of the printing operation.

FIG. 4 illustrates an example of jam codes corresponding to paper jams detected by the respective sensors of the image forming apparatus 1.

In FIG. 3 and FIG. 4, PS33 to PS56 denote sensors. For example, in a case where 100 sheets are printed per minute, a sheet passes through the above-described respective sensors (PS33 to PS56) every 0.6 seconds. In a case where a sheet does not pass through at the time at which this sheet is supposed to pass through, there is a possibility that a paper jam occurs, and if the conveyance of the sheets is not urgently stopped, the sheets are consecutively conveyed to the paper jam occurrence location, which may lead to damage of the conveyance system. For that reason, the timer for the jam detection is set to stop the sheet conveyance as soon as possible in a case where a paper jam is detected.

If the transfer of the print data to the printer unit 400 is delayed, the sheet does not pass through the respective sensors at the time at which the sheet is supposed to pass through as described above. Therefore, according to the present exemplary embodiment, in a case where it is determined that the sheet conveyance is highly likely to be delayed because of a temporary decrease in the data transfer speed to the SSD 215, a time-out period of the above-described timer for the jam detection is extended to avoid the jam detection. Hereinafter, this operation will be described by using FIG. 2A.

In S1, the CPU 201 sets an initial value in a paper jam detection timer. This value is a setting value in a case where the SSD 215 operates at the initial transfer speed (in a state in which the transfer speed is not decreased). In a case where the paper jam detection is performed by a controller (not illustrated) in the printer unit 400, the initial value of the paper jam detection timer described above is set in this controller.

Next, in S2, the CPU 201 waits for a job input. Then, in a case where it is determined that the job is input (in the case of Yes in S2), the CPU 201 advances the processing to S3. The input print job is stored in the SSD 215, and subsequently, the CPU 201 performs control such that the processing operations from S3 to S8 are executed for every print page of the print job.

In S3, the CPU 201 performs the transfer speed measurement processing illustrated in FIG. 2B, and when the transfer speed measurement processing is completed, the CPU 201 shifts the processing to S4. Although not illustrated, the CPU 201 performs control such that the processings are sequentially started with regard to the print job stored in the SSD 215. That is, the PDL data stored in the SSD 215 is converted into the display list and written again to the SSD 215 via the DRAM 202. Furthermore, the control is performed such that the display list written to the SSD 215 is converted into raster data by the RIP unit 207 to be written again to the SSD 215.

In S4, the CPU 201 compares the transfer speed measured in S3 with a predetermined value (for example, 60 [MB/sec]) and determines whether or not the garbage collection is in progress in the SSD 215 depending on whether or not the transfer speed measured in S3 is lower than the predetermined value. In a case where it is determined that the transfer speed measured in S3 is higher than or equal to the predetermined value (in the case of No in S4), the CPU 201 determines that the garbage collection is not in progress in the SSD 215 and shifts the processing to S6.

On the other hand, in a case where it is determined that the transfer speed measured in S3 is lower than the predetermined value (in the case of Yes in S4), the CPU 201 determines that the garbage collection is in progress in the SSD 215 and shifts the processing to S5. In S5, the CPU 201 sets an extended value as the paper jam detection timer value (time-out period) in accordance with the data transfer speed measured in S3. For example, when the data transfer speed measured in S3 is 40 [MB/sec], the paper jam detection timer value is set to be “60/40” times as high as the initial value. In this manner, for example, the time-out period is extended in accordance with a ratio of the measured data transfer speed to the above-described predetermined value. In the case of the configuration in which the paper jam detection is performed by the controller (not illustrated) in the printer unit 400, the thus extended paper jam detection timer value (time-out period) is set in the controller in the printer unit 400.

Next, in S6, the CPU 201 reads out the raster data corresponding to the currently processed page from the SSD 215 to be transmitted to the printer unit 400 via the printer image processing unit 212. Herein, the data transmitted to the printer unit 400 is the data obtained when the display list read out from the SSD 215 is converted into the raster data and transferred again to the SSD 215 as described above. Therefore, when the data transfer speed to the SSD 215 is decreased, the transfer (write) of the above-described raster data to the SSD 215 is delayed, and the data transmission to the printer unit 400 in S6 is also delayed.

Next, in S7, the determination of the occurrence of a paper jam on the basis of the thus set paper jam detection timer value is performed (paper jam determination processing). This paper jam determination processing may be performed by the CPU 201 or may be performed by the controller (not illustrated) in the printer unit 400.

Next, in S8, the CPU 201 determines whether or not a remaining page to be printed exists. In a case where it is determined that a remaining page to be printed exists (in the case of Yes in S8), the CPU 201 shifts the processing to S3, advances the processings to that for the next page, and executes the transfer speed measurement for the printing of the next page.

On the other hand, in S8, in a case where it is determined that a remaining page does not exist (in the case of No in S8), the CPU 201 ends the processing of this job and ends the processing of this flow chart.

FIG. 2A illustrates the configuration in which the transfer speed measurement processing (S3) is carried out for every page. However, if a temporal margin or the like exists until the apparatus is stopped even in a case where it is determined that a paper jam occurs, for example, the transfer speed measurement processing of the SSD 215 may also be performed at an arbitrary timing such as every other page or every two other pages (for example, every plural pages). In the case of this configuration, when it is determined in S8 that a remaining page exists, if the next page is a page where the transfer speed measurement is not performed, the CPU 201 shifts the processing from S8 to S6.

The transfer speed measurement processing (S3) may also be performed for every job. In the case of this configuration, when it is determined in S8 that a remaining page exists, the CPU 201 shifts the processing from S8 to S6.

As described above, according to the present exemplary embodiment, the data transfer speed measurement for the SSD is realized by transferring a file having a predetermined size to the SSD and measuring a period until the execution is completed. That is, according to the present exemplary embodiment, hardware for measuring the transfer speed is not to be newly installed, and the measurement processing for the transfer speed can be realized by only processing based on software.

Therefore, it is possible to avoid a malfunction detection by the image forming apparatus 1 when the transfer speed of the SSD is temporarily decreased, and the functions of the image forming apparatus can be continued. For example, the timer value for determination of a paper jam is temporarily extended to an optimal value in accordance with the data transfer speed, so that while the function for performing the appropriate paper jam determination is maintained, a temporary decrease in the print speed can be allowed. In this manner, according to the present exemplary embodiment, the cost increase is avoided since additional hardware is not required, and the reliability in terms of components can be maintained.

### Second Exemplary Embodiment

According to the above-described first exemplary embodiment, the configuration has been described in which, in a case where the data transfer speed to the SSD 215 is slower than the predetermined value, the control is performed to extend the time-out value of the paper jam detection timer in accordance with the data transfer speed. According to a second exemplary embodiment, a configuration of restricting an execution of a job including the processing through the intermediary of the SSD 215 in a case where the data transfer speed to the SSD 215 is slower than the predetermined value will be described.

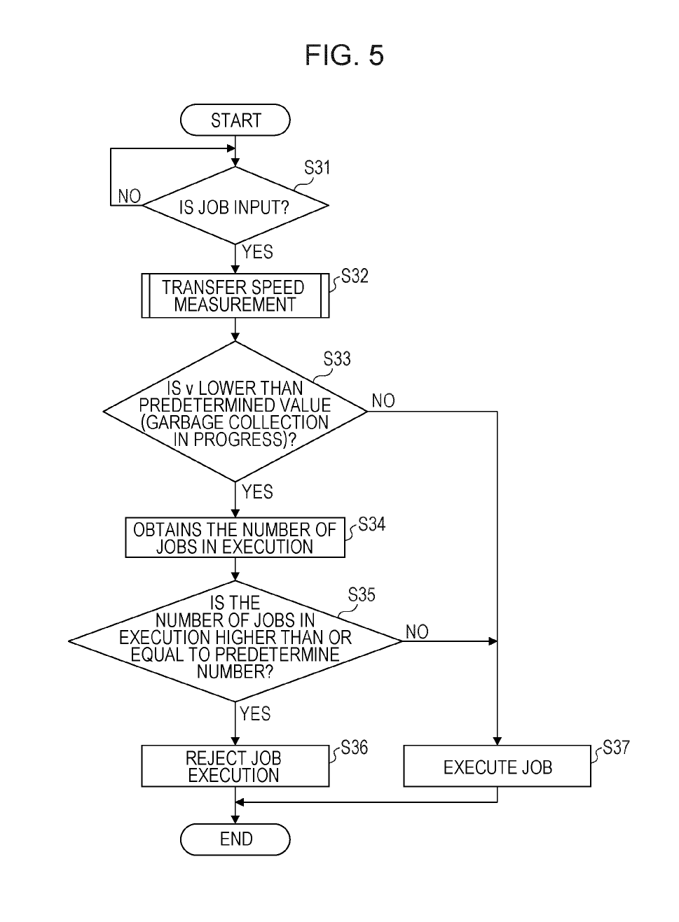

Hereinafter, with reference to FIG. 5, the printing operation of the image forming apparatus 1 according to the second exemplary embodiment will be described.

FIG. 5 is a flow chart illustrating an example of the printing operation of the image forming apparatus 1 according to the second exemplary embodiment. The processing of this flow chart is realized when the CPU 201 of the controller unit 200 executes the program stored in the ROM 203.

In S31, the CPU 201 waits for a job input. Then, in a case where it is determined that the job is input (in the case of Yes in S31), the CPU 201 advances the processing to S32. In S32, the CPU 201 performs the transfer speed measurement processing illustrated in FIG. 2B, and when the transfer speed measurement processing is completed, the CPU 201 shifts the processing to S33.

In S33, the CPU 201 compares the transfer speed measured in S32 with the predetermined value (for example, 60 [MB/sec]) and determines whether or not the garbage collection is in progress in the SSD 215 depending on whether or not the transfer speed measured in S32 is lower than the predetermined value. In a case where it is determined that the transfer speed measured in S32 is higher than or equal to the predetermined value (in the case of No in S33), the CPU 201 determines that the garbage collection is not performed, and in S37, the CPU 201 executes the job received in S31.

On the other hand, in a case where it is determined that the transfer speed measured in S32 is lower than the predetermined value (in the case of Yes in S33), the CPU 201 determines that the garbage collection is in progress in the SSD 215 and shifts the processing to S34. In S34, the CPU 201 obtains the number of jobs currently in execution. The number of jobs obtained herein is the number of jobs including the processing through the intermediary of the SSD 215.

Next, in S35, the CPU 201 determines whether or not the number of jobs currently in execution obtained in S34 is higher than or equal to a predetermined number. In a case where it is determined that the number of jobs currently in execution is lower than the predetermined number (in the case of No in S35), in S37, the CPU 201 executes the job received in S31.

On the other hand, in a case where it is determined that the above-described number of jobs currently in execution is higher than or equal to the predetermined number (in the case of Yes in S35), in S36, the CPU 201 rejects the execution of the job received in S31. The job where the execution is rejected herein is put into a standby state. The CPU 201 also thereafter monitors the number of jobs currently in execution (jobs through the intermediary of the SSD 215), and in a case where the number of jobs currently in execution is lower than the predetermined number, the control is performed to execute the job that is put into the standby state where the execution has been rejected in S36.

Herein, the configuration has been illustrated in which the execution of the job received in S31 is rejected, and the concurrently executed jobs including the processing through the intermediary of the SSD 215 are restricted. However, the concurrently executed jobs including the processing through the intermediary of the SSD 215 may be restricted by stopping the already executed job. For example, in the case of Yes in S35, the CPU 201 displays a list of the already executed jobs obtained in S34 (the jobs including the processing through the intermediary of the SSD 215) on the operation unit 100 and asks a user to select the job to be stopped from the jobs displayed in the list and the jobs input in S31. Furthermore, the execution of the job selected to stop by the user is stopped, and the CPU 201 may continue the execution of the other jobs.

According to the present second exemplary embodiment, for example, by restricting the concurrently executed jobs while the timer value for determination of a paper jam is temporarily set in accordance with the data transfer speed, a temporary decrease in the data transfer speed of the SSD can be allowed while the function of appropriately determining the occurrence of a paper jam is maintained. In this manner, according to the present exemplary embodiment, the cost increase is avoided since additional hardware is not required, and the reliability in terms of components can be maintained.

According to the first exemplary embodiment, the configuration has been described in which, in a case where the data transfer speed to the SSD 215 is slower than the predetermined value, the control is performed to extend the time-out value of the paper jam detection timer in accordance with the data transfer speed. In addition, according to the second exemplary embodiment, the configuration has been described in which, in a case where the data transfer speed to the SSD 215 is slower than the predetermined value, the execution of the above-described job including the processing through the intermediary of the SSD 215 is restricted. However, controls in combination of the above-described first and second exemplary embodiments may also be performed. For example, in a case where the data transfer speed to the SSD is slower than the predetermined value, the execution of the job including the processing through the intermediary of the SSD is restricted as in the second exemplary embodiment, and with regard to the job in execution, the control may also be performed to extend the above-described time-out value in accordance with the data transfer speed as in the first exemplary embodiment.

In a case where the above-described data transfer speed is slower than a first threshold and is faster than a second threshold, the above-described time-out value is extended in accordance with the data transfer speed as in the first exemplary embodiment. In a case where the data transfer speed is slower than the second threshold, the execution of the above-described job including the processing through the intermediary of the SSD 215 may be restricted as in the second exemplary embodiment. It is noted that the following relationship of the first threshold>the second threshold is established.

According to the above-described respective exemplary embodiments, the configuration has been illustrated in which, in a case where the job including the processing through the intermediary of the SSD functioning as the storage apparatus is processed, the data transfer speed of the SSD is measured, the time-up value is changed to be extended, and the number of jobs to be executed is controlled. However, the above-described storage apparatus is not limited to the SSD. For example, other storage apparatus such as CompactFlash (registered trademark), an SD memory, an MMC, or an eMMC may also be employed. Any storage apparatus may be employed so long as the data transfer speed is decreased temporarily or decreased in a case where the lifespan nearly comes to the end or the like in the storage apparatus. For example, other storage apparatus that performs processing similar to the garbage collection in the SSD may be employed. In some storage apparatuses where the number of writes is restricted, the writing speed may be decreased to keep the lifespan of the storage apparatus until the end of its guarantee period, and such storage apparatus may also be employed.

The operation in the case where the print job is input has been described according to the above-described respective exemplary embodiments, but the present invention is not only applied to the printing processing but also is applicable to any processing so long as the processing includes an access to the storage apparatus (for example, the SSD).

For example, the processing may also be a scan job for performing reading processing in which the original is read by the scanner unit 300 to generate image data to be stored in the storage apparatus (the SSD 215 in the configuration of FIG. 1). In addition, the processing may also be a copy job in which the image data read by the scanner unit 300 is processed through the intermediary of the storage apparatus to be printed by the printer unit 400. Moreover, the processing may also be a box job for performing storage processing in which the print data or the like received via the network interface 205 is stored in the storage apparatus (the SSD 215 in the configuration of FIG. 1.)

In the case of the above-described scan job, when the data transfer speed is slower than the predetermined value, the CPU 201 performs a control to extend a time-up value for scan waiting processing in accordance with the data transfer speed. Alternatively, in a case where the number of currently executed jobs through the intermediary of the storage apparatus is higher than or equal to a predetermined number, the control is performed to reject the scan job. Alternatively, controls in combination of the above-described first and second exemplary embodiments are executed. Accordingly, it is possible to avoid the error caused by the time-up of the scan wanting processing derived from the decrease in the data transfer speed of the storage apparatus.

In the case of the above-described copy job, when the data transfer speed is slower than the predetermined value (threshold), the CPU 201 performs the control to extend the time-up value for the scan waiting processing and the time-up value for the paper jam determination processing in accordance with the data transfer speed. Alternatively, in a case where the number of currently executed jobs through the intermediary of the storage apparatus is higher than or equal to the predetermined number, the control is performed to reject the copy job. Alternatively, controls in combination of the above-described first and second exemplary embodiments are executed. Accordingly, it is possible to avoid the error caused by the time-up of the scan waiting processing and the paper jam derived from the decrease in the data transfer speed of the storage apparatus.

Furthermore, in the case of the above-described box job, the control is performed to extend the time-up value used for determining the occurrence of a time-up when the print data or the like received from an external part is written to the storage apparatus in accordance with the data transfer speed. Alternatively, in a case the number of currently executed jobs through the intermediary of the storage apparatus is higher than or equal to a predetermined number, the control is performed to reject the box job. Alternatively, controls in combination of the above-described first and second exemplary embodiments are executed. Accordingly, it is possible to avoid the error caused by the write waiting time-up for the print data or the like to the storage apparatus derived from the decrease in the data transfer speed of the storage apparatus.

With the change control of the time-out period for determining the occurrence of a time-out associated with the processing including the access to these storage apparatuses, while the image forming apparatus 1 keeps the function of performing the appropriate error determination, a temporary decrease in the data transfer speed of the storage apparatus can be allowed. In addition, the cost increase is avoided since additional hardware is not required, and the reliability in terms of components can be maintained.

In the case of using the storage apparatus where the number of writes is restricted such as the SSD, when it is determined that the data transfer speed of the storage apparatus is lower than the predetermined value, the lifespan determination of the storage apparatus may be performed by referring to a write erase count value or the like of the storage apparatus. A configuration may also be adopted in which, in a case where the write erase count value of the storage apparatus exceeds a predetermined value, the CPU 201 determines that the storage apparatus comes to the end of its lifespan and notifies the user of this effect by displaying the information on the display unit of the operation unit 100 or the like. Accordingly, it is possible to avoid a situation that the user keeps using the image forming apparatus as it is (for example, in a state where the print speed is decreased because of the decrease in the data transfer speed) without realizing the end of the lifespan of the storage apparatus.

As described above, even in a case where the operation speed of the storage apparatus used for the processing is decreased, it is possible to maintain the functions of the information processing apparatus without increasing the cost such as the addition of the hardware or causing the critical damage to the information processing apparatus. For example, while the function of performing the appropriate determination of the occurrence of a paper jam in the print job is maintained, a temporary decrease in the print speed can be allowed.

### Other Embodiments

Embodiments of the present invention can also be realized by a computer of a system or apparatus that reads out and executes computer executable instructions recorded on a storage medium (e.g., non-transitory computer-readable storage medium) to perform the functions of one or more of the above-described embodiment(s) of the present invention, and by a method performed by the computer of the system or apparatus by, for example, reading out and executing the computer executable instructions from the storage medium to perform the functions of one or more of the above-described embodiment(s). The computer may comprise one or more of a central processing unit (CPU), micro processing unit (MPU), or other circuitry, and may include a network of separate computers or separate computer processors. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2013-158464 filed Jul. 31, 2013, which is hereby incorporated by reference herein in its entirety.

What is claimed is:

1. An information processing apparatus comprising:
a storage apparatus;
a measurement unit configured to measure a data transfer speed to the storage apparatus; and
a control unit configured to perform a change control to change a time-out period for determining occurrence of a time-out associated with processing including an access to the storage apparatus in accordance with the data transfer speed determined to be lower than a predetermined value.

2. The information processing apparatus according to claim 1, wherein in a case where the data transfer speed is lower than, the control unit changes the time-out period to be extended in accordance with the data transfer speed determined to be lower than the predetermined value.

3. The information processing apparatus according to claim 1, further comprising:
a printing unit configured to perform printing on the basis of print data,
wherein the processing including the access to the storage apparatus is print processing of processing the print data through an intermediary of the storage apparatus to be printed by the printing unit, and
wherein the time-out period is a period for determining the occurrence of a paper jam in the print processing.

4. The information processing apparatus according to claim 3,
wherein the measurement unit measures the data transfer speed for every print page in the print processing, and
wherein the control unit performs the change control for every print page.

5. The information processing apparatus according to claim 1, further comprising:
a reading unit configured to read an original to generate image data,
wherein the processing including the access to the storage apparatus is reading processing of storing the image data generated by the reading unit in the storage apparatus, and
wherein the time-out period is a time-out period used when the image data is stored in the storage apparatus in the reading processing.

6. The information processing apparatus according to claim 1,
wherein the processing including the access to the storage apparatus is storage processing of storing data received from an external part in the storage apparatus, and
wherein the time-out period is a time-out period used when the data is stored in the storage apparatus in the storage processing.

7. An information processing apparatus comprising:
a storage apparatus;
a measurement unit configured to measure a data transfer speed to the storage apparatus; and
a control unit configured to restrict an execution of processing including an access to the storage apparatus according to the measurement that the data transfer speed is lower than a threshold.

8. The information processing apparatus according to claim 7, wherein the control unit restricts the number of concurrently executed processings including the access to the storage apparatus.

9. The information processing apparatus according to claim 8, wherein the control unit restricts an execution of new processing including an access to the storage apparatus in a case where the number of currently executed processings including the access to the storage apparatus exceeds a predetermined number.

10. The information processing apparatus according to claim 8, wherein the control unit stops an execution of an already executed job in a case where the number of currently executed processings including the access to the storage apparatus exceeds a predetermined number.

11. The information processing apparatus according to claim 8, wherein in a case where the number of currently executed processings including the access to the storage apparatus exceeds a predetermined number, the control unit stops an execution of an already executed job, and accepts a user selection of a job to be stopped from a list of jobs to be newly executed and stops an execution of the job corresponding to the accepted user selection.

12. The information processing apparatus according to claim 7, wherein the processing including the access to the storage apparatus includes printing processing of processing print data through an intermediary of the storage apparatus to be printed by a printing unit, reading processing of reading an original by a reading unit and generating image data, or storage processing of storing data received from an external part in the storage apparatus.

13. An information processing apparatus comprising:
a storage apparatus;
a measurement unit configured to measure a data transfer speed to the storage apparatus; and
a control unit configured to change, in a case where the data transfer speed measured by the measurement unit is lower than a first threshold, a time-out period for determining the occurrence of a time-out associated with processing including an access to the storage apparatus in accordance with the data transfer speed, and restrict an execution of the processing including the access to the storage apparatus in a case where the data transfer speed is lower than a second threshold.

14. The information processing apparatus according to claim 1, wherein the storage apparatus is a storage apparatus having a garbage collection function.

15. The information processing apparatus according to claim 1, wherein the storage apparatus is a storage apparatus in which the number of writes is restricted.

16. A control method for an information processing apparatus including a storage apparatus, the control method comprising:
measuring, by a measurement unit, a data transfer speed to the storage apparatus; and
performing, by a control unit, a change control to change a time-out period for determining the occurrence of a time-out associated with processing including an access to the storage apparatus in accordance with the data transfer speed determined to be lower than a predetermined value.

17. A control method for an information processing apparatus including a storage apparatus, the control method comprising:
measuring, by a measurement unit, a data transfer speed to the storage apparatus; and
restricting, by a control unit, an execution of processing including an access to the storage apparatus according to the measurement that the data transfer speed is lower than a threshold.

18. A control method for an information processing apparatus including a storage apparatus, the control method comprising:
measuring, by a measurement unit, a data transfer speed to the storage apparatus; and
changing, by a control unit, in a case where the measured data transfer speed is lower than a first threshold, a time-out period for determining the occurrence of a time-out associated with processing including an access to the storage apparatus in accordance with the data transfer speed, and restricting an execution of the processing including the access to the storage apparatus in a case where the data transfer speed is lower than a second threshold.
